(19) United States
(12) Patent Application Publication
(10) Pub. No.: US 2023/0218074 A1
(43) Pub. Date: Jul. 13, 2023

(54) BRUSH CLEANER CONTROL DEVICE

(71) Applicant: Bo Zhang, Shenzhen (CN)

(72) Inventors: Bo ZHANG, Shenzhen (CN); Yunxiang Rao, Shenzhen (CN)

(21) Appl. No.: 17/574,591

(22) Filed: Jan. 13, 2022

(51) Int. Cl. A46B 15/00; B06B 1/02; A46B 13/02

(52) U.S. Cl. CPC A46B 15/0004; B06B 1/0207; A46B 13/023; A46B 2200/3073

(57) ABSTRACT

A brush cleaner control device includes a housing disposed with an adapter. The adapter is disposed with a brush. A control circuit is disposed in the housing, and the control circuit includes a power supply, a MCU based controller, a switch control circuit, a driving circuit, a speed adjustment circuit, a vibration control circuit and a vibration motor. The power supply is used to supply the MCU based controller with power, the MCU based controller is used to control the driving circuit through the switch control circuit, the driving circuit is used to drive the vibration control circuit through the speed adjustment circuit, and the vibration control circuit is used to control the vibration motor. Therefore, the brush cleaner control device is with high intelligence, diverse functions, flexible control, easy to use and can be controlled wirelessly.

### TECHNICAL FIELD

The invention relates to the field of vibration massage, and more particularly to a brush cleaner control device.

### BACKGROUND

Existing rod-shaped brushes such as cosmetic brushes and writing brushes are washed/cleaned directly with cleaning fluids or water, which are very difficult to be cleaned thoroughly. Generally, a silicone washboard is used for cleaning, but it is easy to blow up bristles or damage the brushes. In addition, a drying method of the cleaned brush is natural drying, which takes a long time and is very inconvenient.

In particular, conventional brush cleaners are not simple enough to clean articles, are not flexible enough to control, inconvenient to use, and their functions are single, which can not meet needs of cleaning articles of consumers.

### SUMMARY

In view of the drawbacks in the prior art, an main objective of the invention is to provide a brush cleaner control device with high intelligence, diverse functions, flexible control, easy to use and can be controlled wirelessly.

To achieve the above objective, the invention provides a brush cleaner control device, and the brush cleaner control device may include a housing disposed with an adapter, and the adapter being disposed with a brush. A control circuit is disposed in the housing, and the control circuit includes a power supply, a microcontroller unit (MCU) based controller, a switch control circuit, a driving circuit, a speed adjustment circuit (also referred to as speed regulating circuit), a vibration control circuit and a vibration motor. The power supply is configured to supply the MCU based controller with power, the MCU based controller is configured to control the driving circuit through the switch control circuit, the driving circuit is configured to drive the vibration control circuit through the speed adjustment circuit, and the vibration control circuit is configured to control the vibration motor.

In an embodiment, the MCU based controller includes a microcontroller chip with a model of GD32E230.

In an embodiment, the power supply is disposed with a charging circuit, and the charging circuit is configured to charge the power supply. Of course, those skilled in the art can know that the power supply can be a DC current, which can directly supply power through DC.

In an embodiment, the vibration control circuit includes a rotary vibration control circuit, and the rotary vibration control circuit is configured to control rotary vibration.

In an embodiment, the MCU based controller includes a drying control circuit, and the drying control circuit is configured for drying.

In an embodiment, the drying control circuit includes a temperature control circuit, a heating control circuit, a fan and an electric motor; the temperature control circuit is configured to control the heating control circuit, and the electric motor is configured to control the fan to blow air toward the heating control circuit.

In an embodiment, the heating control circuit includes an electric heating wire.

In an embodiment, the MCU based controller includes an indicator.

In an embodiment, the MCU based controller includes a display screen, and the display screen is configured to display vibration information.

In an embodiment, the MCU based controller includes a wireless transceiver, and the wireless transceiver is configured to receive and transmit signals.

In an embodiment, the wireless transceiver includes a Bluetooth transceiver.

In an embodiment, the adapter is disposed with a bending shaft, and the brush is connected to the adapter through the bending shaft.

Technical solutions of the invention may have the beneficial effects that: 1) the MCU based controller of the invention controls the vibration of the vibration motor to clean through the speed adjustment circuit, which has high intelligence, flexible operation and convenient use; 2) the invention has diversified functions and is safe and reliable to use; and, 3) the invention has a reasonable structure, can be remotely controlled, greatly reduces labor cost, is easy to universally promote, and has good user experience.

### BRIEF DESCRIPTION OF DRAWINGS

In order to more clearly illustrate technical solutions of embodiments of the invention or the prior art, drawings used in the descriptions of the embodiments or the prior art will be briefly introduced below. Apparently, the drawings in the following description are only some of embodiments of the invention. For those skilled in the art, without paying creative labor, other drawings can be obtained according to structures shown in these drawings.

FIG. 1 is a schematic structural view of a brush cleaner control device of an embodiment of the invention.

FIG. 2 is a schematic structural view of a brush cleaner control device of another embodiment of the invention.

FIG. 3 is a schematic structural view of a brush cleaner control device of still another embodiment of the invention.

FIG. 4 is a schematic control circuit diagram of a brush cleaner control device of an embodiment of the invention.

FIG. 5 is a schematic control circuit diagram of a brush cleaner control device of another embodiment of the invention.

Description of reference signs:

| Reference | | Reference | |
|---|---|---|---|
| sign: | Description: | sign: | Description: |
| 100 | housing | 5 | speed adjustment circuit |
| 101 | key switch | 6 | vibration control circuit |
| 102 | indicator | 61 | rotary vibration control circuit |
| 103 | display screen | 7 | vibration motor |
| 200 | adapter | 8 | drying control circuit |
| 300 | brush | 81 | temperature control circuit |
| 301 | bending shaft | 82 | heating control circuit |
| 1 | power supply | 821 | electric heating wire |
| 11 | charging circuit | 83 | fan |
| 2 | MCU based controller | 84 | electric motor |
| 3 | switch control circuit | 9 | wireless transceiver |
| 4 | driving circuit | 91 | Bluetooth transceiver |
| 201 | shaft sleeve | 400 | base |

The realization of objectives, functional features and advantages of the invention will be further described with reference to the accompanying drawings, in conjunction with embodiments.

### DETAILED DESCRIPTION OF EMBODIMENTS

Technical solutions in embodiments of the invention will be clearly and completely described below in conjunction with the accompanying drawings in the embodiments of the invention. Apparently, the described embodiments are only some of embodiments of the invention, not all of the embodiments of the invention. Based on the illustrated embodiments of the invention, all other embodiments obtained by those skilled in the art without creative work should belong to the protection scope of the invention.

It should be noted that in the illustrated embodiments of the invention, all directional indications (such as up, down, left, right, front, rear . . . ) are only used to explain relative positional relationships and motions among components under a specific attitude (as shown in the accompanying drawings). If the specific attitude changes, the directional indications will change accordingly.

In the invention, unless otherwise clearly specified and defined, terms “connected”, “disposed” and the like should be understood in a broad sense. For example, “disposed” can be fixed connection, detachable connection or integrated; it can be mechanical connection or electrical connection; it can be directly connected or indirectly connected through an intermediate medium; it can be internal connection between two elements or interaction between two elements, unless otherwise clearly defined. For those skilled in the art, the specific meanings of the above terms in the invention can be understood according to the specific circumstances.

In addition, in the invention, the descriptions such as those involving “first” and “second” are only for descriptive purposes, and cannot be understood as indicating or implying their relative importance or implicitly indicating the numbers/quantities of indicated technical features. Thus, the features defined with “first” and “second” may explicitly or implicitly include at least one such feature. In addition, the technical solutions of various embodiments may be combined with each other, but only on the basis that they can be realized by those skilled in the art, and when a combination of technical solutions is contradictory or unrealizable, it shall be considered that the combination of technical solutions does not exist and is not within the protection scope of the invention.

Embodiments of the invention each provide a brush cleaner control device.

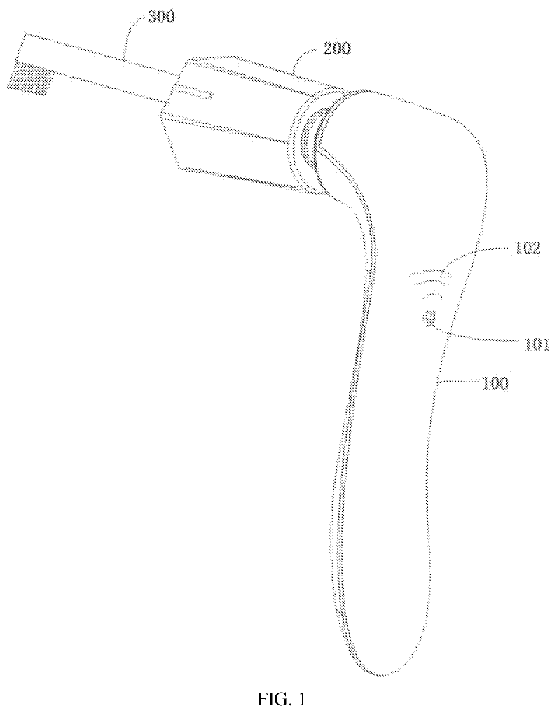

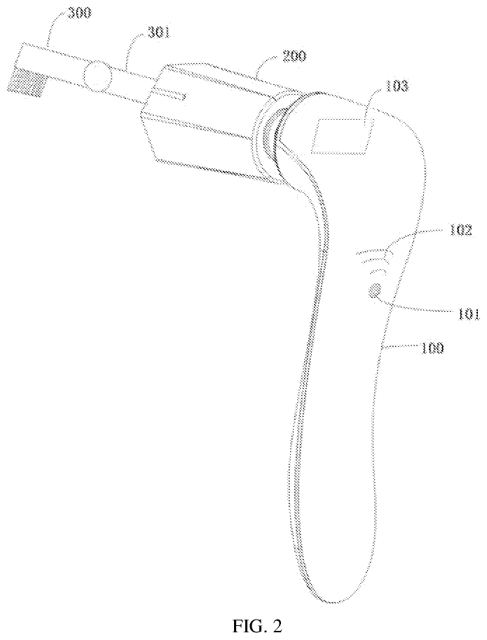

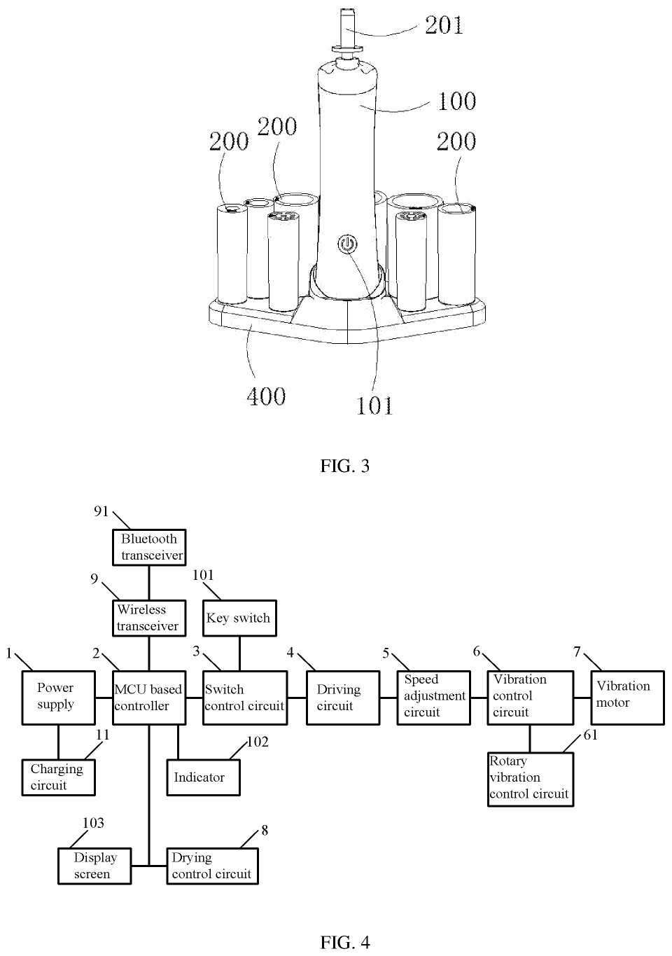

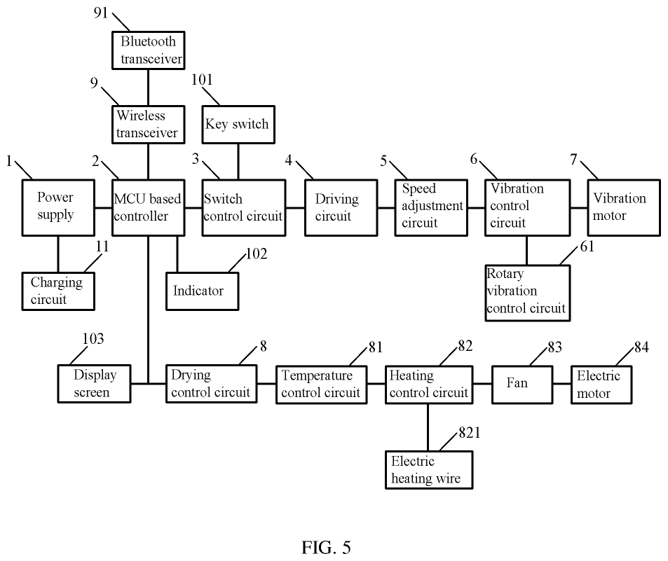

Referring to FIG. 1, FIG. 2, FIG. 3 and FIG. 4, in an embodiment of the invention, the brush cleaner control device includes a housing 100, and the housing 100 is disposed with an adapter 200. A brush 300 is disposed on the adapter 200. The housing 100 has a control circuit disposed therein. The control circuit may include a power supply 1, a microcontroller unit (MCU) based controller, a switch control circuit 3, a driving circuit 4, a speed adjustment circuit 5, a vibration control circuit 6 and a vibration motor 7.

The power supply 1 is configured (i.e., structured and arranged) to supply the MCU based controller 2 with power. The MCU based controller 2 is configured to control the driving circuit 4 through the switch control circuit 3. The driving circuit 4 is configured to drive the vibration control circuit 6 through the speed adjustment circuit 5. The vibration control circuit 6 is configured to control the vibration motor 7.

In an embodiment, preferably, the MCU based controller 2 includes a microcontroller chip with a product model of GD32E230.

In an embodiment, preferably, the power supply 1 is equipped with a charging circuit 11, and the charging circuit 11 is configured to charge the power supply 1.

In an embodiment, the driving circuit 4, the speed adjustment circuit 5, the vibration control circuit 6 an the vibration motor 7 may be disposed in the adapter 200; and the MCU based controller 2 controls the vibration motor 7 through the vibration control circuit 6 to vibrate for cleaning. That is, the vibration motor 7 can vibrate the brush 300 through the adapter 200 to carry out cleaning.

In an embodiment, preferably, the vibration control circuit 6 includes a rotary vibration control circuit 61, and the rotary vibration control circuit 61 is configured to control rotary vibration.

In an embodiment, the rotary vibration control circuit 61 controls the adapter 200 to rotate, and at the same time, the adapter 200 drives the brush 300 to rotate for cleaning, and thus the cleaning is more thorough.

As shown in FIG. 2, in the illustrated embodiment, preferably the adapter 200 is disposed with a bending shaft 301 thereon, and the brush 300 is connected to the adapter 200 through the bending shaft 301.

In an embodiment, the bending shaft 301 may make the brush 300 be bent for cleaning, and thus dead corners of articles can be washed and cleaned thoroughly.

In an embodiment, the rotary vibration control circuit 61 controls the brush 300 to rotate for cleaning, and at the same time, the bending shaft 301 drives the brush 300 to be bent. In this way, the brush 300 may not only rotate, but also bend for brush-cleaning, so that there is no dead corner of cleaning, it is more convenient to clean articles and more flexible to control.

As shown in FIG. 3, in the illustrated embodiment, the invention may further include a base 400. The base 400 is provided with multiple (i.e., more than one) adapters 200 thereon, and thus according to actual situations, corresponding ones of the adapters 200 can be chosen. The housing 100 is provided with a shaft sleeve 201 thereon, and the chosen adapter 200 is connected to the housing 100 through the shaft sleeve 201.

In an embodiment, preferably, the MCU based controller 2 includes a drying control circuit 8, and the drying control circuit 8 is configured for drying.

When the invention is used to clean articles, some of the articles need to be dried in time, the MCU based controller 2 controls the drying control circuit 8 to dry the articles to be dried, which can not only clean the articles, but also use the cleaned articles more timely, and thus the use of the invention is more flexible and convenient.

As shown in FIG. 4, in the illustrated embodiment, preferably, the drying control circuit 8 includes a temperature control circuit 81, a heating control circuit 82, a fan 83, and an electric motor 84. The temperature control circuit 81 is configured to control the heating control circuit 82, and the electric motor 84 is configured to control the fan 83 to blow air towards the heating control circuit 82.

In an embodiment, the temperature control circuit 81 controls the heating control circuit 82 to generate a certain degree of heat, the electric motor 84 controls the fan 83 to blow air towards the heating control circuit 82, and a drying effect is achieved by hot air with a certain degree of heat.

In an embodiment, preferably, the heating control circuit 82 includes an electric heating wire 821, and the drying effect can be realized by producing heat through the electric heating wire 821 and blowing the produced heat through the fan 83.

In an embodiment, preferably, the MCU based controller 2 includes an indicator 102. The on-off of the indicator 102 can display whether the brush cleaner control device has a power supply. The on-state of the indicator 102 indicates the power supply is turned-on, while the off-state of the indicator 102 indicates the power supply is turned-off.

In an embodiment, preferably, the switch control circuit 3 includes a key switch 102, and the key switch 101 is disposed on the housing 100. The key switch 101 can be used to control the vibration motor 7 to vibrate.

In an embodiment, preferably, the MCU based controller 2 includes a display screen 103, and the display screen 103 is configured to display vibration information. The display screen 103 is disposed on the housing 100.

In an embodiment, preferably, the wireless transceiver 9 includes a Bluetooth transceiver 91.

In an embodiment, the MCU based controller 2 controls the wireless transceiver 9 to receive/transmit signals, i.e., the invention can receive a remote control signal through the wireless transceiver 9 to control the brush cleaner control device to vibrate for cleaning, and in this way, it is more convenient to use and more flexible to operate.

Moreover, the invention may further transmit vibration information to a control apparatus through the wireless transceiver 9, for example, it can transmit the vibration information to a smart phone, and the vibration cleaning state of the invention can be reflected through the smart phone.

The smart phone can not only be used as a remote controller to remotely control the vibration cleaning of the brush cleaner control device, but also monitor the vibration information of the vibration motor 7, so as to monitor the cleaning states of articles.

In an embodiment, the wireless transceiver 9 may be a Bluetooth transceiver 91, or other wireless transmission module such as WiFi transceiver, or 4G/5G wireless transceiver.

The invention may have advantages of high intelligence, flexible control, convenient use, random adjustment of vibration cleaning, greatly reducing the cost of manual cleaning, and is a technical upgrade of brush cleaning device in the art.

The above description is only preferred embodiments of the invention and does not limit the scope of protection of the invention. On the premise of without departing from the spirit and scope of the invention, the invention will have various changes and improvements. All equivalent structural transformations made by using the specification and accompanying drawings of the invention under the inventive concept of the invention, or directly/indirectly applied in other relevant technical fields should be included in the scope of protection of the invention.

1. A brush cleaner control device comprising: a base, a housing, a plurality of adapters of different sizes, and a shaft sleeve;
wherein a first end of the housing is detachably disposed on and in contact with the base, the plurality of adapters are independent from one another and detachably disposed on and in contact with the base and thereby the housing and the plurality of adapters are detachably disposed on and in contact with the same base, the shaft sleeve is disposed on an opposite second end of the housing facing away from the base and configured to connect only one adapter each time chosen from the plurality of adapters to the housing after the chosen one adapter is detached from the base, and the chosen one adapter is configured to be disposed with only one brush to be cleaned at a time when the housing is detached from the base;
wherein the brush cleaner control device further comprises a bending shaft, the bending shaft extends in a direction facing away from the housing, a first end of the bending shaft is connected to an end of the chosen one adapter facing away from the housing, an opposite second end of the bending shaft is connected to the only one brush to be cleaned, the bending shaft is arranged between the chosen one adapter and the only one brush, and the bending shaft is configured to make the only one brush to be cleaned bend for cleaning;
wherein a control circuit is disposed in the housing, and the control circuit comprises a power supply, a microcontroller unit (MCU) based controller, a switch control circuit, a driving circuit, a speed adjustment circuit, a vibration control circuit and a vibration motor;
wherein the power supply is configured to supply the MCU based controller with power, the MCU based controller is configured to control the driving circuit through the switch control circuit, the driving circuit is configured to drive the vibration control circuit through the speed adjustment circuit, and the vibration control circuit is configured to control the vibration motor.

2. The brush cleaner control device according to claim 1, wherein the MCU based controller comprises a microcontroller chip with a model of GD32E230.

3. The brush cleaner control device according to claim 1, wherein the power supply is disposed with a charging circuit, and the charging circuit is configured to charge the power supply.

4. The brush cleaner control device according to claim 3, wherein the vibration control circuit comprises a rotary vibration control circuit, and the rotary vibration control circuit is configured to control rotary vibration.

5. The brush cleaner control device according to claim 1, wherein the MCU based controller comprises a drying control circuit, and the drying control circuit is configured for drying.

6. The brush cleaner control device according to claim 5, wherein the drying control circuit comprises a temperature control circuit, a heating control circuit, a fan and an electric motor; the temperature control circuit is configured to control the heating control circuit, and the electric motor is configured to control the fan to blow air toward the heating control circuit.

7. The brush cleaner control device according to claim 6, wherein the heating control circuit comprises an electric heating wire.

8. The brush cleaner control device according to claim 7, wherein the MCU based controller comprises an indicator.

9. The brush cleaner control device according to claim 8, wherein the MCU based controller comprises a display screen, and the display screen is configured to display vibration information.

10. The brush cleaner control device according to claim 1, wherein the MCU based controller comprises a wireless transceiver, and the wireless transceiver is configured to receive a remote control signal to control the brush cleaner control device to vibrate for cleaning and transmit vibration information for reflecting a vibration cleaning state to a smart phone.

11-12. (canceled)

13. A brush cleaner control device comprising: a base, a housing, a plurality of adapters of different sizes, a shaft sleeve, and a control circuit including a MCU based controller;
wherein the housing is disposed on the base, the plurality of adapters are detachably disposed on and in contact with the base, the shaft sleeve is disposed on an end of the housing away from the base and configured to connect only one adapter each time chosen from the plurality of adapters to the housing after the chosen one adapter is detached from the base, the chosen one adapter is configured to be disposed with one brush to be cleaned at a time and thereby the brush cleaner control device is configured to clean one brush at a time when the housing is detached from the base, and the one brush to be cleaned is able to vibrate and rotate under a control of the brush cleaner control device; and
wherein each of the plurality of adapters is provided with a motor therein.

14. The brush cleaner control device according to claim 13, further comprising: a bending shaft;
wherein the bending shaft extends in a direction facing away from the housing, a first end of the bending shaft is connected to an end of the chosen one adapter facing away from the housing, an opposite second end of the bending shaft is connected to the one brush to be cleaned, the bending shaft is arranged between the chosen one adapter and the one brush, and the bending shaft is configured to make the one brush to be cleaned bend for cleaning.

15. A brush cleaner control device, comprising: a housing, an adapter, a brush to be cleaned, and a bending shaft;
wherein the adapter is disposed on an end of the housing, the bending shaft extends in a direction facing away from the housing, a first end of the bending shaft is connected to an end of the adapter facing away from the housing, a opposite second end of the bending shaft is connected to the brush to be cleaned;
wherein a power supply, a MCU based controller, and a switch control circuit are disposed in the housing;
wherein a driving circuit, a speed adjustment circuit, a vibration control circuit, and a vibration motor are disposed in the adapter; and
wherein the power supply is configured to supply the MCU based controller with power, the MCU based controller is configured to control the driving circuit through the switch control circuit, the driving circuit is configured to drive the vibration control circuit through the speed adjustment circuit, and the vibration control circuit is configured to control the vibration motor.
